(19) United States
(12) Patent Application Publication
(10) Pub. No.: US 2007/0026111 A1
(43) Pub. Date: Feb. 1, 2007

(54) Method for Obtaining a Fluid From a Bag Containing a Cooked Food Item

(75) Inventor: Shelly Leann Cook, Dallas, TX (US)

Correspondence Address: CONLEY ROSE, P.C., 5700 GRANITE PARKWAY, SUITE 330, PLANO, TX, 75024, US

(73) Assignee: Shelly Leann Cook, Dallas, TX (US)

(21) Appl. No.: 11/462,636

(22) Filed: Aug. 4, 2006

Related U.S. Application Data
(63) Continuation-in-part of application No. 10/215,734, filed on Aug. 10, 2002, now abandoned.

(51) Int. Cl. A23B 7/148

(52) U.S. Cl. 426/106

(57) ABSTRACT

A method for removing a fluid from a bag, the method comprising: inserting a food item into a bag, heating the food item to produce a fluid within the bag, positioning the bag over a container, and opening a valve in the bag so that the fluid drains from the bag into the container. Also disclosed is a method for removing a fluid from a bag, the method comprising: inserting a food item into a bag, adding an additive to the bag, sealing the bag to retain the food item and the additive within the bag, heating the food item to produce a fluid within the bag, venting the bag without removing the fluid from the bag, positioning the bag over a container, and opening a valve in the bag so that the fluid drains from the bag into the container.

### CROSS-REFERENCE TO RELATED APPLICATIONS

This is a Continuation-in-Part of U.S. patent application Ser. No. 10/215,734, filed Aug. 10, 2002 and entitled “Roasting Bag,” incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### FIELD

The invention relates generally to food preparation methods and specifically to a method for obtaining a fluid from a bag containing a cooked food item.

### BACKGROUND

When cooking food items, such as beef, pork, turkey, chicken, or fish, the food item is normally placed in a pan and then heated in an oven. If desired, the food item may be basted with a suitable basting fluid such that the food does not dry out during the cooking process. In this case, a container may be used to enclose-the food item and the basting fluid. It is common for the user to desire to remove the fluids from the container after the cooking process is completed. The fluids in the container are generally most desirable when they are hot, and there is not currently a clean, safe, and effective method for removing the hot fluids from the container. The conventional methods frequently result in spillage of the fluids which can cause burns and make a mess. Therefore, a need exists for an improved apparatus and method for removing hot fluids from a cooking container.

### SUMMARY

In one aspect, the invention includes a method for removing a fluid from a bag, the method comprising: inserting a food item into a bag, heating the food item to produce a fluid within the bag, positioning the bag over a container, and opening a valve in the bag so that the fluid drains from the bag into the container. In another aspect, the invention includes a method for removing a fluid from a bag, the method comprising: inserting a food item into a bag, adding an additive to the bag, sealing the bag to retain the food item and the additive within the bag, heating the food item to produce a fluid within the bag, venting the bag without removing the fluid from the bag, positioning the bag over a container, and opening a valve in the bag so that the fluid drains from the bag into the container. In a third aspect, the invention includes a method for removing a fluid from a bag, the method comprising: inserting a food item into a bag, sealing the bag, placing the bag in a cooking device, heating the food item to produce a fluid within the bag, removing the bag from the cooking device, positioning the bag over a container, opening a valve in the bag so that the fluid drains from the bag into the container, adding an additive to the bag, closing the valve, and reheating the food item.

### BRIEF DESCRIPTION OF THE DRAWINGS

FIG. 1 is a plan view of one embodiment of the bag;

FIG. 2 is a perspective view of one embodiment of the bag;

FIG. 3A is a perspective view of one embodiment of the valve;

FIG. 3B is a perspective view of another embodiment of the valve;

FIG. 3C is a perspective view of another embodiment of the valve;

FIG. 3D is a perspective view of another embodiment of the valve;

FIG. 4 is a flowchart of one method for obtaining a fluid from the bag; and

FIG. 5 is a perspective view of one embodiment of draining the fluids from the bag.

### DETAILED DESCRIPTION OF THE PREFERRED EMBODIMENT

Disclosed herein is a novel bag for cooking a food item and method for obtaining a fluid from the bag containing the cooked food item. The bag contains a valve that allows the fluid to be drained from the bag while retaining the food item within the bag. The bag also contains a handle so that the bag may be positioned such that the valve is above a container that receives the fluid as the fluid drains from the bag. In addition, the bag may contain a vent that allows steam and other hot gases to be removed from the bag prior to the removal of the fluid from the bag. The combination of these features allows users to retrieve the fluids from the bag with a reduced risk of spilling the fluid and being burnt.

FIGS. 1 and 2 illustrate of one embodiment of a bag 100. As shown, the bag 100 comprises a body 102 and a valve 104. The bag may also comprise a handle 106, a vent 116, a sealed end 112, and an open end 114. A food item 108 may be positioned within the interior of the bag 100. In addition, the bag 100 may include a structure 110 to support the bag 100 and the food item 108. Each of these bag components is discussed in greater detail below.

In an embodiment, the bag 100 comprises the body 102. The body 102 is a generally cylindrical or rectangular tube-like structure that is sized to accommodate the food item 108. For example, the body 102 may be a square or rectangular piece of material that is rolled and connected on two opposite sides so as to form the cylindrical shape. The body 102 may be creased in various locations to produce the rectangular shape. The body 102 may also be creased in various locations so as to facilitate easy collapse and expansion of the body 102. Such collapsible and expandable features are advantageous because they allow the bag 100 to be collapsed into a relatively flat shape, which is advantageous in packaging the bag 100 for retail sale. In addition, the relatively flat shape allows an increased quantity of the bags 100 to be packaged together in a single box, which reduces the overall shipping and handling cost associated with each the bag 100.

In an embodiment, the bag 100 also comprises the valve 104. The valve 104 may be any structure that may be changed from a closed configuration in which the fluid is retained within the bag, to an open configuration in which the fluid may be released from the bag. In an embodiment, the valve 104 does not open or close when the valve 104 is heated. Such an embodiment is advantageous because it retains the fluids within the bag 100 when the bag 100 is heated. In an embodiment, the valve 104 may be repeatedly changed from an open configuration to a closed configuration. Such an embodiment is advantageous when a user wants to drain some or all of the fluid from the bag 100, and then continue to cook the food item 108. The valve 104 may be located on any side of the bag 100 and the bag 100 may be configured with a plurality of valves 104, if desired.

The valve 104 may be used to facilitate the release of gases, liquids, or both from the bag 100. For release of gases, the bag 100 is oriented with the valve 104 in a position where it is not in contact with any fluids contained within the bag 100. In this position, the act of opening the valve 104 will release the hot gases contained within the bag 100 without releasing any of the fluids contained within the bag 100. For release of fluids, the bag 100 is oriented with the valve 104 in a position where it is in contact with the fluids contained within the bag 100. In this position, the act of opening the valve 104 will release the fluids contained within the bag 100. Alternatively, fluids may be removed from the bag 100 by opening the valve 104 when the valve 104 is not in contact with the fluids, and then the bag 100 may be reoriented such that the fluids will drain out of the open valve 104.

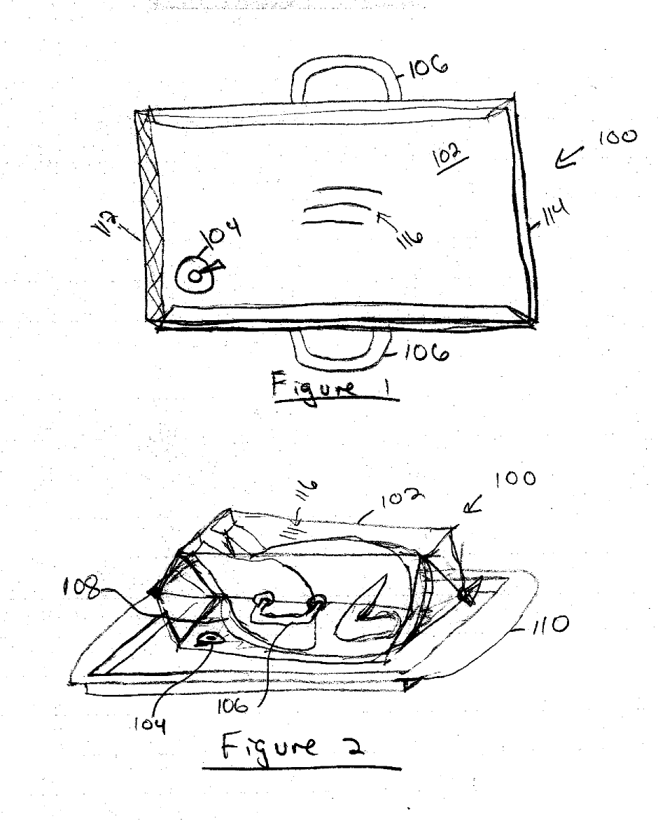

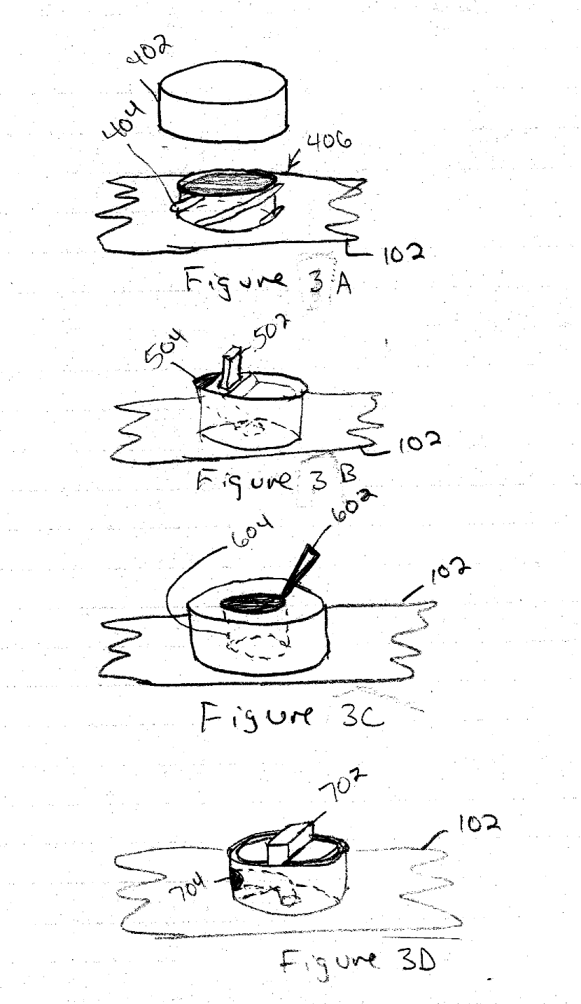

There are many different configurations of the valve 104 that may be used in the bag 100. FIG. 3A is an illustration of a screw on cap type valve which may be implemented on the bag 100. Here, the valve consists of cap 402 which screws onto threads 404 on the lower half of the valve assembly 406. Optional plug (not shown) may be inserted into the lower half of the valve assembly 406 to further seal the valve when cap 402 is screwed onto the lower valve assembly 406. The lower valve assembly 406 is affixed to the body 102 and contains threads 404 that mate with threads (not shown) on the inside of the cap 402.

FIG. 3B is an illustration of a push type valve which may be implemented on the bag 100. Push type valves may normally be: found on disposable fluid containers, such as brewed tea containers and box wine bags. In a push type valve assembly, the valve is normally closed. However, when release 502 is pushed in a specific direction, such as away from cavity 504, the valve opens and the fluids inside the body 102 may drain out via cavity 504.

FIG. 3C is an illustration of a pull type valve which may be implemented on the bag 100. Pull type valve is a single use valve that is normally sealed. When pull tab 602 is pulled away from the valve body, cavity 604 is exposed. Fluids may then drain out of the body 102 through cavity 604. Pull type valves are commonly used on cans of liquids, such as soda cans.

FIG. 3D is an illustration of a twist type valve which may be implemented on the bag 100. In a twist type valve, a channel exists inside the body of the valve as indicated by the dotted line in FIG. 3D. To open the valve, handle 702 is turned so that cavity 704 is exposed to the inside of the body 102 through the channel in the valve body. When this occurs, fluids may drain out of the body 102 through the valve channel and cavity 704.

Returning to FIGS. 1 and 2, in an embodiment, the bag 100 also comprises at least one handle 106. The handles 106 are used to position and orient the bag 100 to facilitate the draining of the fluid from the bag 100. The handles 106 are particularly useful when the orientation of the bag 100 needs to be changed to promote the draining of fluids from the bag 100. The handles 106 may be attached to the sides of the bag 100, but may alternatively be attached to the top and bottom of the bag 100. Persons of ordinary skill in the art know how to attach the handles 106 to the bag 100 such that the handles 106 will support the weight of the bag 100, the food item 108, and any fluids in the bag 100. A person skilled in the art will also know the best location to attach the handles 106 to the bag 100 such that fluids will easily drain out of the bag 100 via the valve 104. In an embodiment, the handles 106 may include excess material attached to the body 102 such that the stress of the handles 106 on the body 102 is distributed over a greater area on the body 102. Such excess material may partially or completely encircle the bag 100. If the bag 100 contains a plurality of the handles 106, the excess material may connect some or all of the handles 106.

In an embodiment, the bag 100 also comprises the vent 116. The vent 116 is a perforation in the bag 100 that allows steam and other gases to escape the bag 100. The vent 116 may be covered with a piece of tape or similar closure (not shown) during the heating of the food item 108. The tape or similar closure may be removed to expose the vent 116 and allow the release of gases from the bag 100. Alternatively, the vent 116 may be exposed in order to vent the bag 100 and achieve more efficient draining of fluids from the bag 100 via the valve 104. If desired, the vent may include a valve that allows steam and other gases to escape the bag 100, while retaining fluids and other liquids within the bag 100. In a specific embodiment, the valve may be activated by pressure or temperature and configured to open prior to rupture or melting of the bag 100. Such an embodiment is advantageous because it allows the vent to open and release some or all of the steam and other gases, thereby preventing damage to the bag 100.

In an embodiment, the bag 100 also comprises the sealed end 112 and the open end 114. The sealed end 112 is sufficiently sealed such that any food items, fluids, or gases in the bag 100 cannot escape through the sealed end 112. Food items and/or additives, such as seasoning or basting fluids, may be placed into the bag 100 through the open end 114. The bag 100 is sufficiently large such that when the food items and/or basting juices are placed inside the bag 100, the open end 114 may still be closed, for example, with a twist tie (not shown). Alternatively, the open end 114 can be sealed with a freezer or sandwich bag style closure (i.e. a ZIPLOC® style closure). Those skilled in the art will also be aware of other methods of sealing the open end 114. When the open end 114 is closed, the bag 100 will be sufficiently sealed such that the food items, the additives, any other fluids, or any gases will not be able to escape the bag 100 through the sealed open end 114. In the preferred embodiment, the bag 100 has one sealed end 112 and one open end 114. In alternative embodiments, the bag 100 may have two open ends 114. This embodiment facilitates easy handling of the food items prior to open ends 114.

In an embodiment, the bag 100 also comprises the structure 110. The structure 110 may be any apparatus that supports the bag 100 and/or the food item 108. In an embodiment, the structure 110 is an apparatus that is external to the bag 100, such as a tray or a baking sheet. In another embodiment, the structure 110 is an apparatus that is positioned within the bag 100, such as an internal framework. In an embodiment, such an internal structure 110 may be configured such that it positions the food item 108 above the bottom of the bag 100 so as to separate the food item 108 from any fats or other undesirable fluids that may be produced by the food item 108 during the application of heat thereto.

The bag 100 may be constructed of any material suitable for the purpose described herein. The bag 100 should be constructed of a material with sufficient mechanical integrity to support the weight of the food item 108 when the bag 100 is supported by the handles 106. In one embodiment, the bag 100 is made of a non-thermoplastic material, such as silicone or metal foil. Aluminum foil is one example of a metal foil that may be suitable for the purposes described herein. In another embodiment, the bag 100 is made of thermoplastic materials, such as polyethylene, polypropylene, polyester, polyvinyl chloride, polyamides, or polystyrene. Because the bag 100 is subjected to heat, the material used to form the bag 100 may remain substantially physically unchanged at temperatures up to about 400°, about 600° F., or about 800° F. However, in one embodiment, the bag 100 may shrink or otherwise deform when heat is applied thereto. Such an embodiment is useful because it increases the contact area between the food item 108 and any fluids within the bag 100, which may assist in seasoning the food item 108. While the various bag components described herein may be made of the same material, it is also envisioned that the various bag components described herein may be made of different materials so that each component may perform its particular function more effectively.

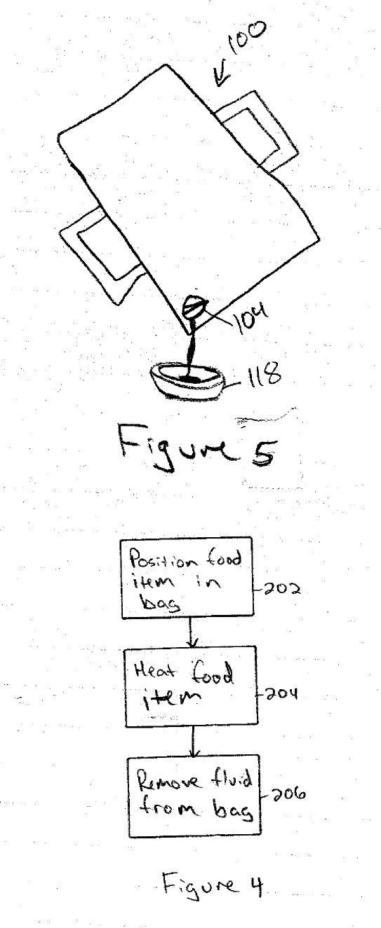

FIG. 4 is a flowchart of one method for removing the fluid from the bag. The disclosed method is advantageous when the user desires to remove the fluid from the bag without removing the cooked food item from the bag. Generally, the method comprises: positioning the food item in the bag at block 202, heating the food item at block 204, and removing the fluid from the bag at block 206. Each of these steps is described in greater detail below.

In an embodiment, the method includes positioning the food item in the bag at block 202. Generally, the user begins by acquiring the bag and expanding the bag if the bag is collapsed. The chef then inserts the food item and optionally additives, such as seasoning or basting fluid, into the bag. For example, the user can insert the food item and additives into the bag through the open end. The bag is then sealed to secure the food item and additives within the bag.

In an embodiment, the method also includes heating the food item at block 204. The heating of the bag and the food item may be in the form of such as cooking, baking, roasting, sautéing, grilling, or any other heating method. Such heating methods are generally carried out in an oven, stove, microwave, grill or other cooking device. The application of heat to the food item generally cooks the food item to a level suitable for human consumption. The heating of the food item may also produce various fluids from the food item, such as fats, juices, or other fluids. After the food item has been sufficiently cooked, the bag and food item are removed from the cooking device and allowing it to cool. The user may also vent the bag so as to remove steam and other hot gases, if desired.

In an embodiment, the method also includes removing the fluid from the bag at block 206. The user may remove the fluid from the bag by positioning the bag over a container, for example,. using the handles. The user then opens the valve and allows the fluid in the bag to drain out of the bag and into the container. FIG. 5 illustrates the process of draining the fluid from the bag into a container 118 using the valve 104. The fluid captured in the container may then be used in further cooking processes, such as to prepare a gravy or other sauce.

In an embodiment, the method may also include reheating the bag and the food item. In such an embodiment, the valve may be closed and the bag and food item returned to the cooking device for further cooking. In such an embodiment, the user may insert additives into the bag through the valve prior to closing the valve. Alternatively, the user may insert additives into the bag by opening the open end of the bag, inserting the additives into the bag, and then resealing the open end. The user may then reheat the food item in the cooking device, reheat the food item, and then remove the reheated food item from the cooking device at a later time. The user may then remove any additional fluids from the bag using, for example, the procedure described above.

With respect to the above description, it is to be realized that the optimum dimensional relationships for the parts of the invention, to include variations in size, materials, shape, form, function and manner of operation assembly and use, are deemed readily apparent and obvious to one skilled in the art, and all equivalent relationships to those illustrated in the drawings and described in the specification are intended to be encompassed by the present invention. Additionally, the steps of the present invention need not be implemented in the order disclosed herein. The novel spirit of the present invention is still embodied by reordering or deleting some of the steps contained in this disclosure. The spirit of the invention is not meant to be limited in any way except by proper construction of the following claims.

What is claimed is:

1. A method for removing a fluid from a bag, the method comprising:
inserting a food item into a bag;
heating the food item to produce a fluid within the bag;
positioning the bag over a container; and
opening a valve in the bag so that the fluid drains from the bag into the container.

2. The method of claim 1 further comprising: adding an additive to the bag.

3. The method of claim 1 further comprising: sealing the bag prior to heating the food item.

4. The method of claim 1 further comprising: venting the bag subsequent to heating the food item.

5. The method of claim 1 further comprising: preparing a gravy or sauce using the fluid.

6. The method of claim 1 further comprising: cooling the bag prior to opening the valve.

7. The method of claim 1 further comprising:
closing the valve subsequent to opening the valve; and
reheating the food item.

8. The method of claim 1 further comprising:
adding an additive to the bag subsequent to opening the valve;
closing the valve; and
reheating the food item.

9. The method of claim 1 further comprising:
placing the bag in a cooking device prior to heating the food item; and
removing the bag from the cooking device subsequent to heating the food item.

10. The method of claim 1, wherein the valve is retained in a closed position while heating the food item.

11. The method of claim 1, wherein the valve does not require heat to be opened.

12. The method of claim 1, wherein the valve can be repeatedly opened and closed.

13. The method of claim 1, wherein a handle is used to position the bag over the container.

14. The method of claim 1, wherein the bag is made of a thermoplastic material.

15. A method for removing a fluid from a bag, the method comprising:
inserting a food item into a bag;
adding an additive to the bag;
sealing the bag to retain the food item and the additive within the bag;
heating the food item to produce a fluid within the bag;
venting the bag without removing the fluid from the bag;
positioning the bag over a container; and
opening a valve in the bag so that the fluid drains from the bag into the container.

16. The method of claim 15, wherein the valve is a screw cap valve, a push valve, a pull valve, or a twist valve.

17. The method of claim 15, wherein the valve is retained in a closed position until the valve is opened.

18. A method for removing a fluid from a bag, the method comprising:
inserting a food item into a bag;
sealing the bag;
placing the bag in a cooking device;
heating the food item to produce a fluid within the bag;
removing the bag from the cooking device;
positioning the bag over a container;
opening a valve in the bag so that the fluid drains from the bag into the container;
adding an additive to the bag;
closing the valve; and
reheating the food item.

19. The method of claim 18, wherein the valve does not open or close when it undergoes a change in temperature.

20. The method of claim 18, wherein the bag is made of a non-thermoplastic material.
